(19) United States
(12) Patent Application Publication
(10) Pub. No.: US 2016/0285179 A1
(43) Pub. Date: Sep. 29, 2016

(54) PRINTED CIRCUIT BOARD AND TUBULAR CASING SYSTEM

(71) Applicant: ROSENBERGER HOCHEREQUENZTECHNIK GMBH & CO. KG, Fridolfing (DE)

(72) Inventors: Martin Zebhauser, Laufen (DE); Rainer Bippus, Teisendorf (DE); Holger Brosch, Tittmoning (DE)

(21) Appl. No.: 14/906,719

(22) PCT Filed: Jul. 15, 2014
(86) PCT No.: PCT/EP2014/001934

§ 371 Date: Mar. 4, 2016

(30) Foreign Application Priority Data
Jul. 24, 2013 (DE) 20 2013 006 662.8

(51) Int. Cl. H01R 9/05; H01R 24/50; H01R 12/71

(52) U.S. Cl. CPC H01R 9/0515; H01R 12/716; H01R 24/50; H01R 2107/00

(57) ABSTRACT

A system having a printed circuit board and a tubular casing which is connected to the printed circuit board, the casing contacting the printed circuit board at the front end with a flat, closed, annular contact surface, and the printed circuit board being fully soldered to the casing along the contact surface.

### BACKGROUND OF THE INVENTION

1. Field of the Invention

The invention relates to a system having a printed circuit board and a tubular casing, in particular a conductor, which is connected to the printed circuit board. In particular, the invention relates to a system in which the casing, in particular serving as an outer conductor, surrounds one or more inner conductors of a jacketed and in particular shielded single or multiple-conductor cable (for example a coaxial cable).

2. Description of Related Art

Such systems form a part of numerous devices in which radio frequency signals are transmitted and processed (for example multimedia devices). The inner conductor(s) of the shielded single or multiple cables intended for the transmission of radio frequency signals are connected in an electrically conductive manner with defined conductor traces of the printed circuit board, while the outer conductor (casing) serves as shielding for the inner conductors and for this purpose is generally connected in an electrically conductive manner with a contact region of the printed circuit board which is connected to earth. The connections between the inner and outer conductors and the corresponding contact regions of the printed circuit board can thereby be form-locking, force-locking, or firmly bonded. In many cases soldering is used for a firmly bonded connection, whereby, for cost reasons, when soldering extensive contact surfaces solder joints are created at individual points or over particular sections.

For certain applications it can be necessary to seal the connection between the printed circuit board and the coaxial cable in order, in particular, to prevent moisture from penetrating as far as the inner conductors and their contact points with the conductor traces of the printed circuit board or also to prevent moisture from penetrating via the contact points into a housing surrounding the outer conductor. A separate sealing element, for example a conventional O-ring, which is arranged in the contact region between the printed circuit board and the outer conductor, is often used for this purpose. This form of sealing is associated with relatively high costs, which are due not only to the component costs for the sealing element but also result from the relatively complex assembly of the system.

EP 1 187 268 A2 discloses a coaxially structured connector module for installation on a printed circuit board. For the purpose of connection with the printed circuit board, an earth terminal is pressed onto the front end of a tubular casing. The earth terminal has two spurs projecting downwards. These spurs serve to fix the connector to and make contact with the printed circuit board. For this purpose, the spurs are inserted and, for example, soldered into insertion holes in the printed circuit board.

U.S. Pat. No. 5,116,245 discloses a coaxially structured connector module designed for installation on a printed circuit board. For the purpose of attachment to the printed circuit board, fixing brackets are inserted in contact holes in the printed circuit board and there soldered to an earth conductor. The fixing brackets are not part of an annular contact surface but project at a distance from such a surface in the direction of the printed circuit board as fixing elements.

WO 98/43323 A1 discloses a coaxial connector for connecting two printed circuit boards. The coaxial connector has a first and a second connection element. The first connection element has an axially elastically displaceable inner contact which makes direct contact with a conductor path on one of the printed circuit boards. The second contact piece has a conductor part on the conductor path which is designed to make a plugged connection with a first outer conductor connection element.

### SUMMARY OF THE INVENTION

Starting out from this prior art the invention is based on the problem of providing the possibility of the economical sealing of the connection of a printed circuit board to a jacketed, and in particular, shielded cable.

This problem is solved by a system according to the independent claims. Advantageous embodiments of the system according to the invention are the subject matter of the dependent claims and are explained in the following description of the invention.

The above and other objects, which will be apparent to those skilled in the art, are achieved in the present invention which is directed to a system consisting of a printed circuit board and a tubular casing connected to the printed circuit board, wherein the casing makes contact with the printed circuit board with a flat, closed annular contact surface and the printed circuit board is soldered together with the casing along the contact surface, around its entire periphery, forming a soldered connection, said soldered connection forming a seal preventing moisture from penetrating into the cavity formed by the outer conductor.

The casing is designed as a conductor, which is connected to the printed circuit board in an electrically conductive manner. Additionally, the casing may surround at least one inner conductor.

A wall thickness of the casing is greater in the region of the contact surface than in a section located at a distance from the contact surface.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 shows a first perspective view of a system according to the invention;

FIG. 2 shows a second perspective view of the system; and

FIG. 3: shows a perspective view of a longitudinal section of the system.

### DESCRIPTION OF THE PREFERRED EMBODIMENT(S)

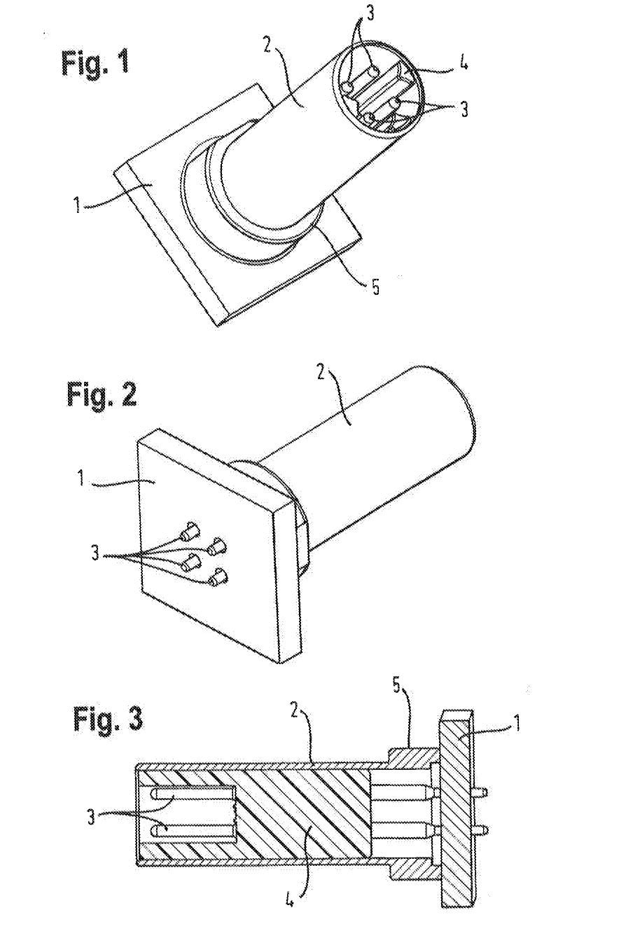

In describing the preferred embodiment of the present invention, reference will be made herein to FIGS. 1-3 of the drawings in which like numerals refer to like features of the invention.

The invention is based on the idea of realizing the connection between the printed circuit board and a tubular casing, in particular an outer conductor of a shielded single- or multiple-conductor cable, through soldering, and designing the soldered connection such that this can simultaneously serve to seal the connection region. For this purpose it is necessary that the soldered connection region extend around its entire periphery in relation to the cross-section of the casing and, in addition, must cover a large enough surface area that an adequately sealing effect can be achieved by the solder introduced into the intermediate contact space between the printed circuit board and the casing.

Accordingly, according to the invention a system consisting of a printed circuit board and a tubular (and preferably electrically conductive) casing, in particular a conductor, which is preferably connected in an electrically conductive manner with the printed circuit board, is characterized in that, on its end face, the casing makes contact with the printed circuit board with a flat, closed, annular (for example circular, square, rectangular, etc.) contact surface, and the printed circuit board is soldered together with the casing along the contact surface, around its entire periphery (preferably over its entire surface area).

In order to obtain a contact surface which is sufficiently large to achieve a good sealing effect, it can be advantageous for the thickness of the contact surface to be greater than the wall thickness of the casing in a section located at a distance from the contact surface. In particular, the thickness of the contact surface can be greater than the normal wall thickness, i.e., the wall thickness which the casing has along the greater part of its length. In order to achieve this, the casing can for example be provided with a thickening at its contact-side end, which can for example be in the form of a peripheral shoulder. The shoulder need not thereby be formed integrally with the (rest of the) casing. Alternatively, it can also be the case for example that the casing has the normal wall thickness at its contact-side end and in order to enlarge the contact surface an end section is bent radially outwards (in particular by) 90°. In order to achieve an adequately good sealing effect it can preferably be the case that the thickness of the annular contact surface amounts to at least 0.3 mm. In addition to an adequately good sealing effect, an increase in the strength of the mechanical connection between the printed circuit board and the casing achieved through the soldering can also be realized through an enlargement of the contact surface.

The sealing the connection between a printed circuit board and a tubular casing according to the invention can in particular be used advantageously if the casing surrounds (at least) one inner conductor. This can in particular be the case if the inner conductor(s) is/are used for the transmission of radio frequency signals and special requirements, in particular in terms of protection against corrosion, are placed on the contact points between the inner conductor and the associated contact regions on the printed circuit board. The casing can in particular thereby be electrically conductive and can also preferably be designed as a conductor. The casing can thus serve as a shielding and in particular as an outer conductor for the inner conductor.

The casing can preferably be formed completely of a suitable metal. This means that it can readily display the preferred electrical conductivity and can in addition also be soldered without any problem. However, the casing can also consist of other materials. For example, the casing can be formed, at least partially, of plastic. In this case the solderability and if necessary the conductivity can for example be achieved by a metallic (partial) coating.

The system according to the invention shown in FIGS. 1 to 3 comprises a printed circuit board 1 and a shielded multiple-conductor cable connected to the printed circuit board 1. The multiple-conductor cable comprises a (electrically conductive) tubular outer conductor 2 with annular (circular) cross-section. Within the outer conductor 2, several, in this case four (electrically conductive) inner conductors 3 are positioned in a square arrangement. The inner conductors 3 are thereby each held in a receiving opening of an insulation element 4. As a result, the inner conductors 3 are both fixed in their position within the outer conductor 2 as well as being electrically insulated from the outer conductor 2 and from the other inner conductors 3.

The contact-side end sections of the inner conductors 3 project through through-openings in the printed circuit board 1 and make contact, on the side distant from the multiple-conductor cable, with respective associated contact regions of conductor traces on the printed circuit board 1. The inner conductors 3 can thereby also be soldered together with the contact regions.

The end face of the outer conductor 2 makes contact with a contact region of the printed circuit board 1 provided for this purpose with a flat, closed annular (circular) contact surface. The mechanical connection between the outer conductor 2 and the associated contact region of the printed circuit board 1 is achieved through soldering, for which purpose molten solder is, in a known manner, introduced into the contact gap formed between the contact surface of the outer conductor 2 and the contact region of the printed circuit board 1.

The soldered connection at the same time serves as a seal in order to prevent moisture from penetrating into the cavity formed by the outer conductor 2. In order to achieve an adequate sealing effect, the soldering takes places along the entire periphery of the closed annular (circular) contact surface. In addition, the wall thickness is selected to be greater in the region of the contact surface than the normal wall thickness of the outer conductor 2. For this purpose, the contact-side end sections of the outer conductor 2 are provided on the outer side with a peripheral shoulder 5, as a result of which an enlargement of the diameter with a resulting enlargement of the cross-sectional surface area is achieved.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A system consisting of a printed circuit board and a tubular casing connected to the printed circuit board, wherein the casing makes contact with the printed circuit board with a flat, closed annular contact surface and the printed circuit board is soldered together with the casing along the contact surface, around its entire periphery, forming a soldered connection, said soldered connection forming a seal preventing moisture from penetrating into the cavity formed by the outer conductor.

2. The system of claim 1, wherein the casing is designed as a conductor which is connected to the printed circuit board in an electrically conductive manner.

3. The system of claim 1, including a wall thickness of the casing being greater in the region of the contact surface than in a section located at a distance from the contact surface.

4. The system of claim 1 wherein the casing surrounds at least one inner conductor.

5. The system of claim 2, including a wall thickness of the casing being greater in the region of the contact surface than in a section located at a distance from the contact surface.

6. The system of claim 5 wherein the casing surrounds at least one inner conductor.
